(19) United States
(12) Patent Application Publication
(10) Pub. No.: US 2010/0000097 A1
(43) Pub. Date: Jan. 7, 2010

(54) WEED TRIMMING DEVICE

(76) Inventor: Donnie F. Johnson, Camdenton, MO (US)

Correspondence Address: James Ray & Associates, 2640 Pitcairn Road, Monroeville, PA, 15146, US

(21) Appl. No.: 12/496,027

(22) Filed: Jul. 1, 2009

Related U.S. Application Data
(60) Provisional application No. 61/077,224, filed on Jul. 1, 2008.

(51) Int. Cl. A01D 34/90; A01D 34/416; B25F 5/02

(52) U.S. Cl. 30/275.4; 30/276; 30/277.4

(57) ABSTRACT

A weed trimming device includes a support member engageable with at least one of a user's back, a user's shoulders, and a combination thereof. Such weed trimming device includes a trimming member having a rotatable blade element for trimming plants and cutting grass and weeds. A motor is attached to such support member and operably connectable to such trimming member for enabling rotational movement of such blade element. A power source is operably connected to such motor for supplying power thereto. A switch mechanism is intermediate such power source and such motor for selectively supplying and terminating power to such motor.

### CROSS REFERENCE TO RELATED APPLICATION

This patent application is related to and claims priority from U.S. Provisional Patent Application Ser. No. 61/077,224 filed Jul. 1, 2008.

### FIELD OF THE INVENTION

The present invention relates, in general, to plant and weed trimming devices and, more particularly, this invention relates to a weed trimming device which is supported in part on a user's back thereby eliminating arm and hand strain and enabling a user greater control over the device while trimming weeds.

### BACKGROUND OF THE INVENTION

Prior to the conception and development of the present invention, weed trimmers as are generally well known in the prior art, have been used to trim areas of yards that are difficult to reach with traditional lawn mowers. Unfortunately, weed trimmers are heavy and cumbersome and as a user carries around the trimming while trying to trim with it, such user's arms become tired and he or she loses control over the device often resulting in unfinished trimming and pain and suffering to the user.

Specifically of interest to the present invention are the following: Salisian, U.S. Pat. No. 6,305,048, discloses a back mountable power apparatus including an enclosure constructed as a back pack. Air is conducted into an air intake chamber, then to an air intake plenum by air impeller. An electric motor is coupled with an air impeller. Air exits through an air exhaust orifice for application in blowing leaves etc. A rotational transmission, terminating with a coupling is adapted for receiving an accessory for operation of the accessory so that a range of garden, carpentry and farming accessories may be utilized with the power take-off.

Will, et al, U.S. Pat. No. 5,857,439, discloses a portable power unit for operating a tool which includes a frame adapted to be carried on the back of an operator to orient the power unit in a predetermined operating position with the operator standing upright. The power unit further includes an engine mounted on the frame for powering a tool, a fan mounted between the frame and the engine, a fan intake positioned between the frame and the fan, and structure for attenuating engine and fan generated noise.

Casper, et al, U.S. Pat. No. 4,989,323, discloses a portable apparatus carried on the back of an operator for operating attachable and detachable power tools.

### SUMMARY OF THE INVENTION

The present invention provides a weed trimming device including a support member engageable with at least one of a user's back, a user's shoulders, and a combination thereof. Such weed trimming device includes a trimming member having a rotatable blade element for trimming plants and cutting grass and weeds. A motor is attached to such support member and operably connectable to such trimming member for enabling rotational movement of such blade element. A power source is operably connected to such motor for supplying power thereto. A switch mechanism is intermediate such power source and such motor for selectively supplying and terminating power to such motor.

### OBJECTS OF THE INVENTION

It is, therefore, one of the primary objects of the present invention to provide a device a weed trimming device which is supported on a user's back and includes a flexible shaft to which the trimming member is attached thereby enabling a user to hold only the shaft and trimming member with his or her hands to utilize the device; the bulk of the weight of the device is supported on such user's back.

Another object of the present invention is to provide a weed trimming device which is primarily supported backpack style by a user's back and shoulders thereby freeing a user's hands and arms of weight and enabling such user to have more control while trimming.

Still another object of the present invention is to provide a weed trimming device which includes a frame member which may be supported on a user's back, such frame member for supporting at least the power source, motor, fuel, etc. of a wood trimming device thereby requiring a user to support less weight of the device on his or her arms or hands enabling such user to trim for longer periods of time and providing numerous advantages to such user.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of the invention according to one embodiment of the invention.

FIG. 2 is a is a partial perspective view of the invention according to one embodiment of the invention.

FIG. 3 is a partial perspective view of the invention according to one embodiment of the invention in which a user is illustrated with the support member secured to his back and shoulders via straps.

FIG. 4 is a schematic view of the invention according to one embodiment of the invention.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

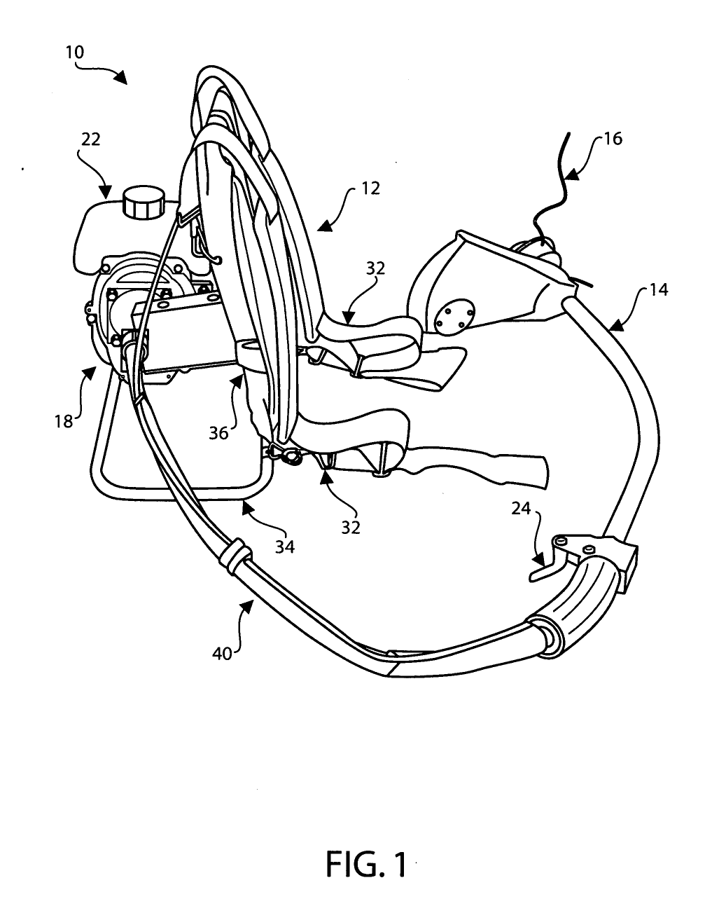

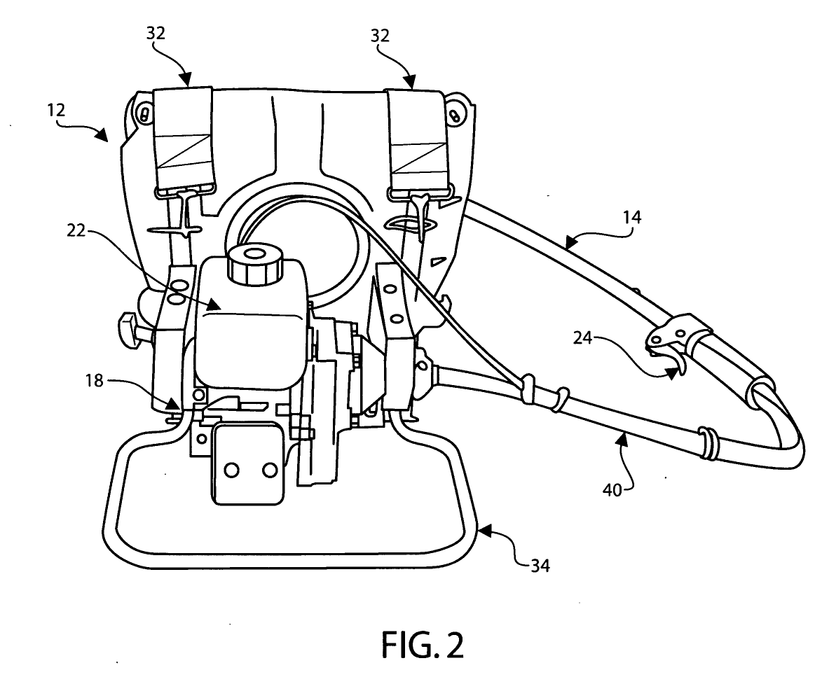

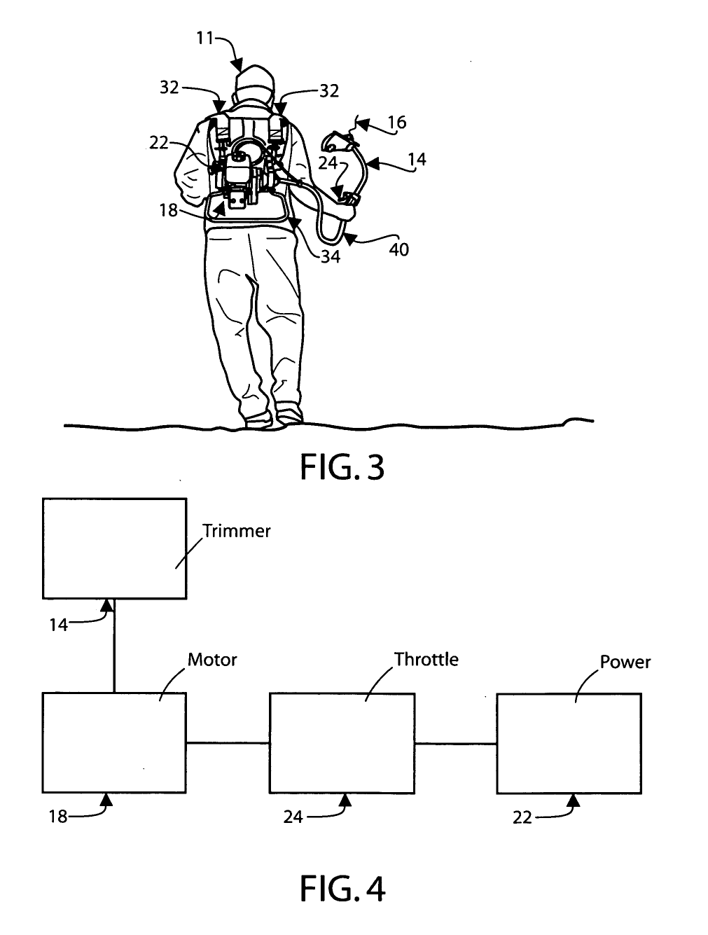

Reference is now made, more particularly, to FIGS. 1-4.

A weed trimming device, generally designated 10, is provided. Such weed trimming device 10 includes a support member 12 engageable with at least one of a user's 11 back, a user's shoulders, and a combination thereof. Such weed trimming device 10 includes a trimming member 14 having a rotatable blade or string element 16 for trimming plants and cutting grass and weeds.

A motor 18 is attached to such support member 12 and operably connected to such trimming member 14 by means of flexible shaft 40 for enabling rotational movement of such blade element 16.

A power source 22 is operably connected to such motor 18 for supplying power thereto. A throttle means 24 is used for selectively supplying and terminating power to motor 18 from said power source 22. It is presently preferred that such power source is at least one of fluid power, electric, at least one battery, and a combination thereof. Preferably, such power source is fluid power. It is presently preferred that such fluid power is at least one of gasoline, oil, and a combination thereof.

Such support member 12 preferably includes a pair of adjustable straps 32 for engaging a user's 11 shoulders therein, such adjustable straps 32 being manufactured from a predetermined material and having a predetermined size and a predetermined shape.

It is presently preferred that such support member 12 includes a metal frame 34. Such metal frame 34 is preferably partially padded on a rear surface there of, such rear padded surface 36 abutting a user's 11 back when such support member 12 is in use.

The device is meant to provide a portable power unit such as those described in the teachings of Casper et al., U.S. Pat. No. 4,989,323 which is incorporated herein by reference, with a weed trimmer being partially supported on at least one of such user's back, such, user's shoulders, and a combination thereof via a support member such that the user need only support and guide a small portion of the device (including the trimming member) with his or her hands thereby eliminating fatigue, hindered mobility, lack of control etc.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A weed trimming device comprising:
a. a support member engageable with at least one of a user's back, a user's shoulders, and a combination thereof;
b. a trimming member including a rotatable blade element for trimming plants and cutting grass and weeds;
c. a motor attached to said support member and operably connectable to said trimming member for enabling rotational movement of said blade element;
e. a power source operably connected to said motor for supplying power thereto; and
f. a switch means intermediate said power source and said motor for selectively supplying and terminating power to said motor.

2. A weed trimming device according to claim 1 wherein said support member includes a pair of adjustable straps for engaging a user's shoulder therein, said adjustable straps being manufactured from a predetermined material and having a predetermined size and a predetermined shape.

3. A weed trimming device according to claim 1 wherein said power source is at least one of fluid power, electric, at least one battery, and a combination thereof.

4. A weed trimming device according to claim 3 wherein said power source is fluid power.

5. A weed trimming device according to claim 4 wherein said fluid power is at least one of gasoline, oil, and a combination thereof.

6. A weed trimming device according to claim 1 wherein said support member includes a metal frame.

7. A weed trimming device according to claim 6 wherein said metal frame is partially padded on a rear surface thereof, said rear padded surface abutting a user's back when said support member is in use.

8. A weed trimming device according to claim 1 wherein said motor is operably connected by means of a flexible shaft to said trimming member for enabling rotational movement of said blade element.

9. A weed trimming device according to claim 1 wherein said blade element comprises a polymer string.

10. A weed trimming device according to claim 1 wherein said blade element comprises a metal string.

11. A weed trimming device according to claim 1 wherein said blade element comprises a metal blade.

12. A weed trimming device according to claim 1 wherein said blade element comprises a polymer blade.

13. A weed trimming device comprising:
a. a support member engageable with at least one of a user's back, a user's shoulders, and a combination thereof;
b. a trimming member including a rotatable blade element for trimming plants and cutting grass and weeds;
c. a motor attached to said support member and operably connectable to said trimming member for enabling rotational movement of said blade element;
e. a power source operably connected to said motor for supplying power thereto; and
f. a throttle intermediate said power source and said motor for selectively supplying and terminating power to said motor.

14. A weed trimming device according to claim 13 wherein said motor is operably connected by means of a flexible shaft to said trimming member for enabling rotational movement of said blade element.

15. A weed trimming device according to claim 13 wherein said blade element comprises a polymer string.

16. A weed trimming device according to claim 13 wherein said blade element comprises a metal string.

17. A weed trimming device according to claim 13 wherein said blade element comprises a metal blade.

18. A weed trimming device according to claim 13 wherein said blade element comprises a polymer blade.
